(19) United States
(12) Patent Application Publication
(10) Pub. No.: US 2014/0067866 A1
(43) Pub. Date: Mar. 6, 2014

(54) JAVASCRIPT OBJECT NOTATION SCHEMA DEFINITION LANGUAGE

(71) Applicant: Hong W. Chen, Kirkland, WA (US)

(72) Inventor: Hong W. Chen, Kirkland, WA (US)

(73) Assignee: MICROSOFT CORPORATION, Redmond, WA (US)

(21) Appl. No.: 13/596,694

(22) Filed: Aug. 28, 2012

(51) Int. Cl. G06F 7/00

(52) U.S. Cl. 707/791; 707/E17.055

(57) ABSTRACT

A schema language is employed to define and validate data encoded in JavaScript Object Notation (JSON). The schema language makes consistent use of name-value pairs, a cornerstone of JSON, enabling a schema to be read and authored easily. More particularly, objects are composed of properties, and properties are composed of an array of name-value pairs, where the name is a string and the value can be almost any type, including another pair. Further, the schema language supports name referencing, alternative schemas, and forbidden type, and a root object to facilitate schema composition, among other things.

### BACKGROUND

JavaScript Object Notation (JSON) is a popular data-interchange format. Typically, JSON is employed to serialize and transmit structured data over a communication network, such as the Internet. Accordingly, JSON can be utilized to facilitate exchange of data between a server and client in conjunction with a web, or other representational state transfer (REST)-based, application/service.

JSON is a favored data-interchange format for several reasons. First, JSON is lightweight compared to other formats such as XML (eXtensible Markup Language). JSON is also easily parsed and generated by machines, and is a text format that is easy for humans to read and write. Additionally, despite being derived from the JavaScript scripting language, JSON is programming language independent, and parsers exist for many different programming languages.

A schema can be utilized to define as well as validate the structure of JSON data beyond syntactic constraints imposed by the notation itself. A schema is a description of a type of JSON payload that conforms to some specific expectation expressed in terms of some custom constraints on structure and/or data type. The schema is defined with a schema definition language, or more simply a schema language. A defined schema can subsequently be employed to determine whether JSON data is valid, wherein the data is valid if it conforms to the schema.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to a JavaScript object notation (JSON) schema definition language. The schema definition language, or simply schema language, is consistent, rendering it intuitive and easy to read and author. Further, the schema language is expressively powerful to enable specification of substantially any expectation, or constraint, on JSON data including those involving recursion, for example. More particularly, the language supports a consistent use of a pair structure including a name and value. Objects are composed of one or more properties, which are composed of an array of one or more pairs of name and value. Further, an object can include mandatory and optional properties, and an array can include mandatory and optional elements. Additionally, the schema language supports schema name referencing, alternative schemas, a forbidden type, and a root object to facilitate schema composition, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a validation system.

FIG. 2 is a block diagram of a JSON schema.

FIG. 3 is a block diagram of an object structure.

FIG. 4 is a flow chart diagram of a validation method.

FIG. 5 is a flow chart diagram of a method of object validation.

FIG. 6 is a schematic block diagram illustrating a suitable operating environment for aspects of the subject disclosure.

### DETAILED DESCRIPTION

Conventionally, JSON schema languages are limited. For example, one schema language (JSON schema draft from Internet Engineering Task Force) is an ad hoc design. As a result, the schema language is very unintuitive, for example with respect to defining properties of an object. Additionally, the schema language is inadequate with respect to schema alternatives, mixes structural/type validation with semantic implications, and instantiates schema by resolving references at definition time. Another schema language (jsonvalidator) is rudimentary and constrained in terms of expressive power. Consequently, there is a lack of ability to express complicated requirements easily. In this instance, it is either impossible to express a complicated requirement in full or the schema produced is difficult to understand, maintain and change.

It is not surprising that conventional JSON schema languages lack expressive power. JSON has heretofore been utilized for simple data payloads. Accordingly, there has been no reason to be concerned with a powerful schema for validation. Additionally, the simplicity of data in combination with the human readability and terseness of JSON militate against complex validation mechanisms. Further yet, a programmatic approach is often utilized. In such an instance JSON data is efficiently tokenized into an in memory object for a host programming language, such as JavaScript. Subsequently, the host programming language is exploited to manipulate a value inside the host language. However, validation is different. Validation is host language neutral and occurs before data is provided to a host language.

JSON continues to be employed for wider uses. In particular, JSON is utilized by a wide range of programming languages and generic protocol. By way of example, and not limitation, the JSON format has been adopted by the open data protocol (OData), a web protocol for querying and updating data. OData is not directed toward the JavaScript programming language at all, but rather is intended to be language neutral. In other words, JavaScript is not available as a host language. Hence, what is needed is a generic way to validate payload to ensure it conforms to a protocol specification, such as OData requirements regarding the JSON format.

Details below are generally directed toward a JSON schema definition language that addresses deficiencies of conventional languages, among other things. The schema language employs pairs of name and value, where name is a string and value can be almost any type including a pair. More particularly, objects are composed of one or more properties, and the properties are composed of array of one or more pairs of name and value. Since pairs are a cornerstone of JSON, consistent support for pairs in the schema language makes the language intuitive to use. The schema language also provides support for recursive name referencing, alternatives, separate mandatory and optional elements of an array and properties of an object, and introduces a forbidden schema to facilitate composition. Consequently, the JSON schema language is expressively powerful and able to capture complex expectations, or constraints on JSON data.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

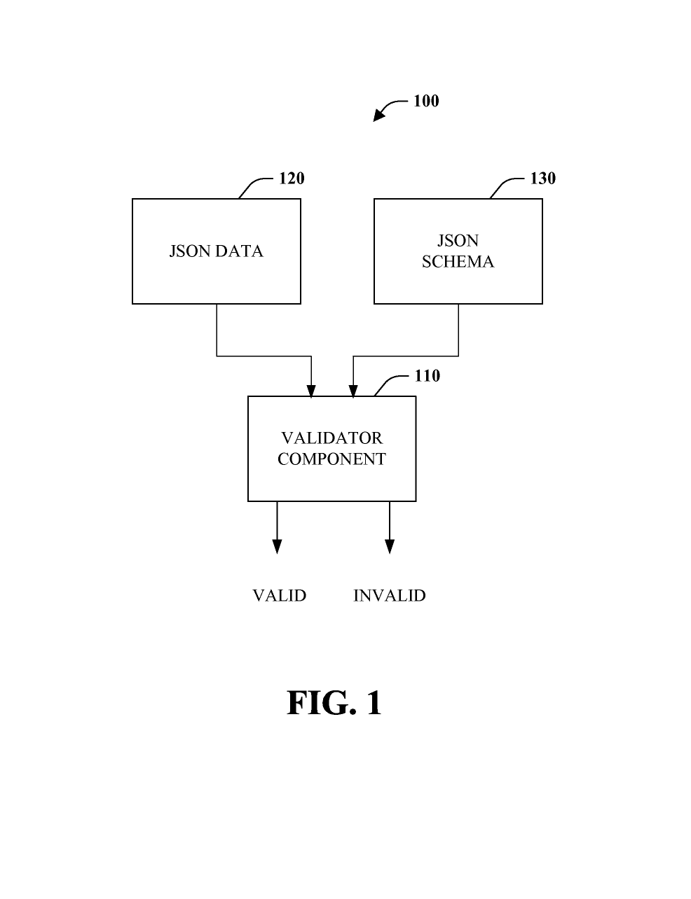

Referring initially to FIG. 1, validation system 100 is illustrated. The system 100 includes validator component 110, which receives as input JSON data 120 and JSON schema 130. JSON data is data specified in the JavaScript object notation, which is a text-based/human-readable data interchange format. In the context of a protocol, the JSON data is also referred to as a JSON payload. In other contexts, JSON data can be termed a JSON document. The JSON schema 130 expresses specific expectations with respect to JSON data in terms of structure, data types, or both structure and data types. The JSON schema is specified in terms of a schema definition language, or more simply a schema language, that is, among other things, both powerful and intuitive, as will be described later herein. The validator component 110 determines whether the JSON data 120 conforms to expectations specified in the JSON schema 130. If the JSON data conforms, it is valid. Otherwise, the JSON data 120 is invalid. The validator component 110 can provide notification in either or both scenarios. For instance, an error message can be provided solely with respect to invalid JSON data to facilitate conforming changes.

It is to be noted that validation is different from well formedness. The latter concerns whether the JSON data is specified in correct JSON syntax. The former pertains to whether the JSON data conforms to specific structure and/or types. Nevertheless, validator component 110 can operate in conjunction with a determination of whether or not data is well formed. For example, the data can be parsed, and if it satisfies JSON syntax, the data can be passed to the validator component 110.

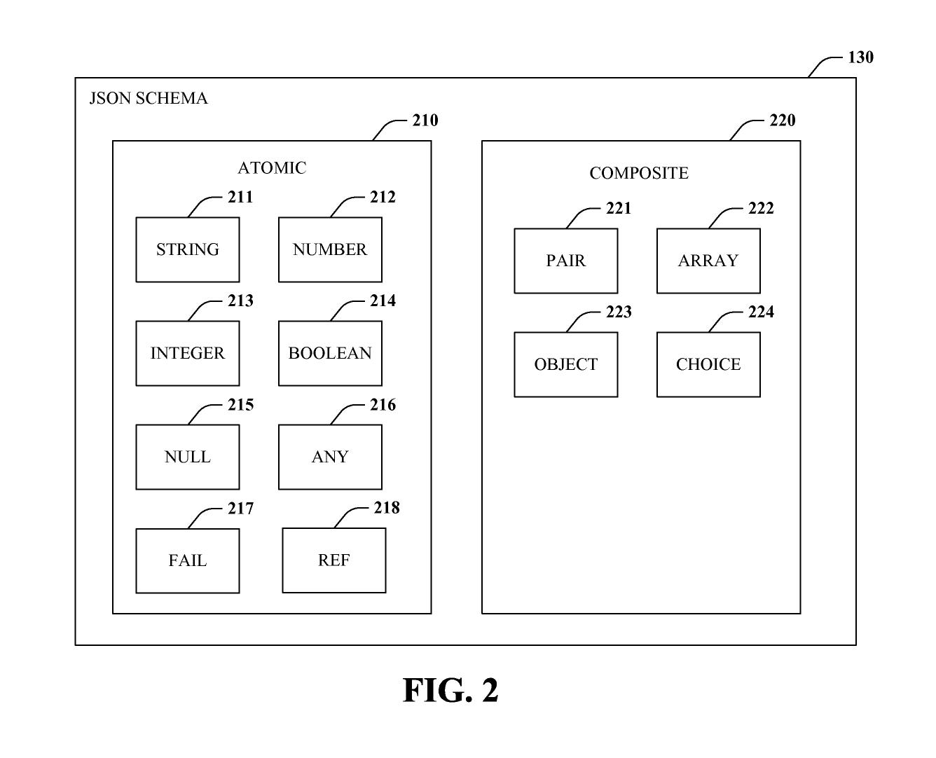

FIG. 2 is a block diagram of JSON schema. The JSON schema is specified in a schema language. As previously mentioned, the JSON schema can define structural and/or data type constraints. The schema language includes a grammar that provides a number of structures with a pattern that describes each structure. Each structure, or more particularly structure definition, can be termed a schema, or sub-schema, which forms a part of the larger JSON schema 130. These structures, or schemas, can be generally divided into atomic structures 210 and composite structures 220

Atomic structures 210 include language primitives including but not limited to string 211, number 212, integer 213, Boolean 214, null 215, any 216, and fail 217 that correspond to JSON data. The structure definition for string 211 with respect to the subject schema language is:

{“type”: “string” (, “value”: [ . . . ])? (, “regex”: “ . . . ”)?}
In other words, a type string is defined. If there are limitations on the value, the limitations can be placed in the value attribute. Further, if the value has some sort of pattern, the regular expression (“regex”) attribute can be utilized to describe the pattern of the string.

The structure definition for number 212 is:

{“type”: “number” (, “value”: [ . . . ])? (, max”: . . . )? (, “min”: . . . )?}
Here, the type is number, so it cannot be a string, for example. By default, any number is satisfactory. However, if there is some limitation on the value it can be specified in the optional value attribute. Further, a minimum and/or maximum can optionally be specified to limit the scope of the value.

The structure definition for integer 213 is:

{“type”: “int” (, “value” “[ . . . ])? (, “max”: . . . )? (, “min”: . . . )?}
The type is integer, and optionally, a limitation on the value of the integer can be specified in the value attribute. Additionally, there are options to set the minimum and/or maximum of value. Accordingly, an integer can be specified to fall within a specific scope of values.

The structure definition for Boolean 214 is:

{“type”: “bool” (, “value”: . . . )?}
The type, here, is Boolean (“bool”), and the value can be either true or false.

The structure definition for null 215 is:

{“type”: “null”}
This unique structure allows specification of null, representing the empty set or meaningless character.

The structure definition for any 216 is:

{“type”: “any”}
This allows specification of any value (e.g., string, number, integer, Boolean . . . ).

Fail 217 has the following structure definition:

{“type”: “fail”}
This means that a particular node in a data structure is forbidden. Accordingly, during validation if the validator reaches such a node the data is invalid, because it includes something that is forbidden.

Ref 218 pertains to named reference to a schema, and the structure definition is:

{“type”: “ref”, “name”: <property name of the schema defined in the outmost wrapper>}
This structure references schemas defined elsewhere by name. In accordance with one embodiment, a schema name can be defined as the property name associated with the schema. In a simple case, reference can be to a schema in the same file. However, support is also provided for schemas residing in different files. Further, named reference to schemas supports schema composition. For example, recursion can be supported by referencing a scheme defined outside and referenced from inside the recursion.

The composite structures 220 include are composed of one or more other structures including atomic and/or composite structures. Four composite structures 220 are shown, namely pair 221, array 222, object 223, and choice 224.

The structure definition of pair 221 is as follows:

{“type”: “pair”, “name”: <string schema for name>, “value”: <schema for value>}
As specified, pair includes a pair of name and value, or, in other words, a name-value pair. The pair name is a string schema or of type string. The value can be of any schema including string, number, or another pair, for example. Here, the name and value are treated equally and consistently. Name-value pairs are the cornerstone of JSON. Accordingly, consistent use of the pair structure makes the language intuitive to design, change, and maintain a schema.

Array 222 has the following structure definition:

{“type” : “array”

(, “elements” : [schema for ordered element> +])?
(, “extra” : [<schema for extra element>+]?)?
(, “unordered” : true | false)

}

Array 222 includes a plurality of elements with a schema for the elements. Furthermore, there can be mandatory and optional array elements, and the array can include ordered or unordered elements depending on whether “unordered” is set to true or false. Array is often referenced, in accordance with JSON syntax, utilizing square brackets (“[” “]”).

The structure definition for object 223 is:

{“type” : “object”

(, “inherit” : [object_schema+])?
(, “properties” : [<pair schema for mandatory property>+])?
(, “extra” : [<pair schema for optional property>+]?)

}

Here, an object 223 is composed of one or properties, which are composed of an array of one or more pairs. Further, object 223 can include mandatory and optional properties. Still further, object 223 can inherit (is a super set) from another object schema. Including object 223 in a schema language also aids constraint expression and use, since object is a composite unit of JSON. Additionally, an entire schema can be wrapped in JSON object corresponding to the root as follows:

{

“root” : <leading schema definition>
(, <property-name> : <named reference schema definition>)*

}

In other words, a root property can be used to indicate the leading schema or entry point in to the schema.

Choice 224 has a structure definition as follows:

{“type”: “choice”, “choices”: “[<schema>+]}
Choice supports schema composition by allowing specification of one or more schema alternatives. In other words, choice 224 accepts an array of schema names. For example, if there are two schemas “A” and “B,” choice indicates that the schema can be either “A” or “B.”

The claimed subject matter is not intended to be limited to those structure definitions provided above. It is to be appreciated that additional data structures and associated definitions are possible and contemplated. Further, of those structures described above alternative definitions are possible. By way of example, and not limitation, different patterns can be introduced for integer such as an ability to express odd and/or even numbers. Additionally, the default type of a name of a name-value pair could be set as string by default. Accordingly, for the name part of pair, the type definition can be eliminated. This improves efficiency, but affects consistent/universal treatment of pairs and thus intuitiveness. Accordingly, care is to be taken in making such tradeoffs.

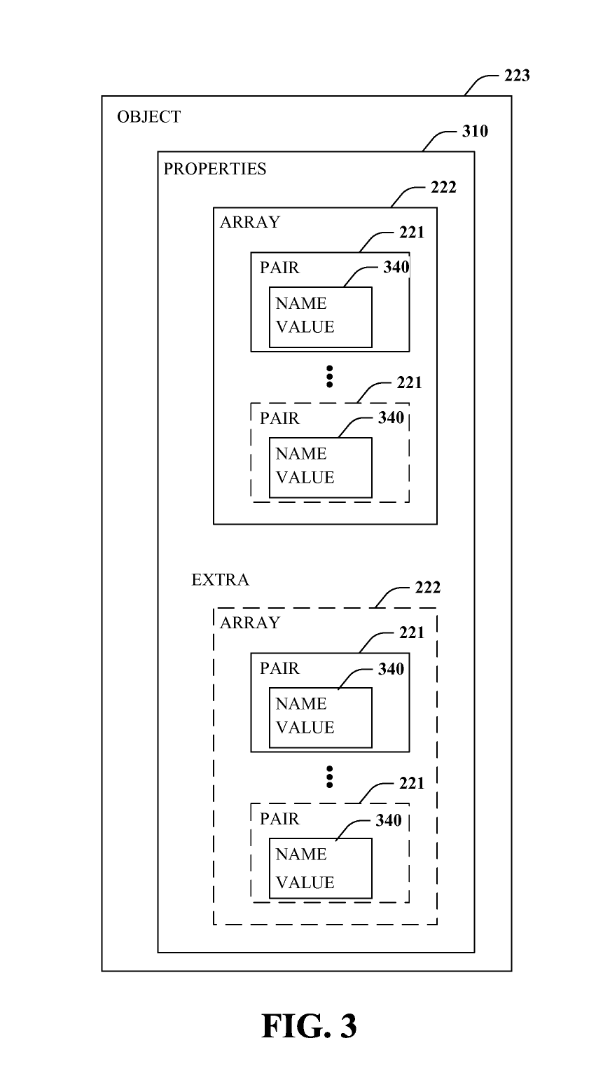

Objects are a foundational structure in JSON. FIG. 3 depicts the object structure 223 as specified in the schema language of the subject disclosure. The object 223, which may or may not be the root object, includes properties 310. The properties 310 are composed of an array 222 of pairs 221. Further, there can be mandatory properties as shown by the array 222 with solid lines, and optional properties as shown by the array 222 with dashed lines. Further, the array 222 can have mandatory pair element shown with solid lines and optional pair elements shown with dashed lines. The pair 221 is composed of a name and value 340, wherein the name is a string and the value can include any type or schema including another pair 221.

By way of example and not limitation, a person object composed of a first name of type string, a last name of type string, and an age of type integer can be specified as follows. Note the array is denoted with brackets (e.g., “[” “]”).

“”root” : {

“type” : “object”
“properties” : [

{

“type” : “pair”
“name” : {“type” : “string”, “value” : [“firstname”]}
“value” : {“type” : “string”}

}
{

“type” : “pair”
“name” : {“type” : “string”, “value” : [“lastname”]}
“value” : {“type” : “string”}

}
{

“type” : “pair”
“name” : {“type” : “string”, “value” : [“age”]}
“value” : {“type” : “int”}

```
  }
  ]
```

}

This JSON schema can be utilized to validate the following JSON data:

{

“firstname” : “John”,
“lastname” : “Jones”,
“age” : 36

}

As another more complicated schema, consider an object that inherits (is a super set) another object type as follows:

{“root”: {″type″:″object″

, ″inherit″: [

{ ″type″: ″object″
,″properties″ : [

{ ″type″ : ″pair″
,″name″ : {″type″ : ″string″}
,″value″: { ″type″ : ″int″ }
}

]}

]}

}

In this instance, any object, as long as it includes a property having “int” has its value, is a compliant object, such as:
{“a”: “b”, “foo”:8, “c”:null}

The subject JSON schema is even able to define recursive wrapping to arbitrary layers around a specific core object, like the following JSON objects:

{“a”: 999},
{“b”: {“a”: 999}},
{“c”:{“b”: {“a”: 999}}},
{“d”:{“c”:{“b”: {“a”: 999}}}},
The corresponding schema is:

{“root”: {“type”: “choice”,

“choices”: [

{“type”: “object”
,”properties”: [

{“type”:”pair”
,”name”:{“type”:”string”}
,”value”:{“type”:”int”}
}

]}
,{“type”: “object”,
“properties”: [

{“type”:”pair”
,“name”: {“type”:”string”}
,”value”: {“type”:”ref”, “name”:”root”}

]}

]

}

Appendix A illustrates use of JSON schema to define the JSON schema itself. Note that in Appendix A the JSON schema of the subject disclosure is called “Jasmin” or “Jasmin schema.” The JSON schema is self-descriptive, which is proof of the expressive power of the schema. Furthermore, the self-descriptive JSON schema provides a reference for a schema author understand how to write a JSON schema.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

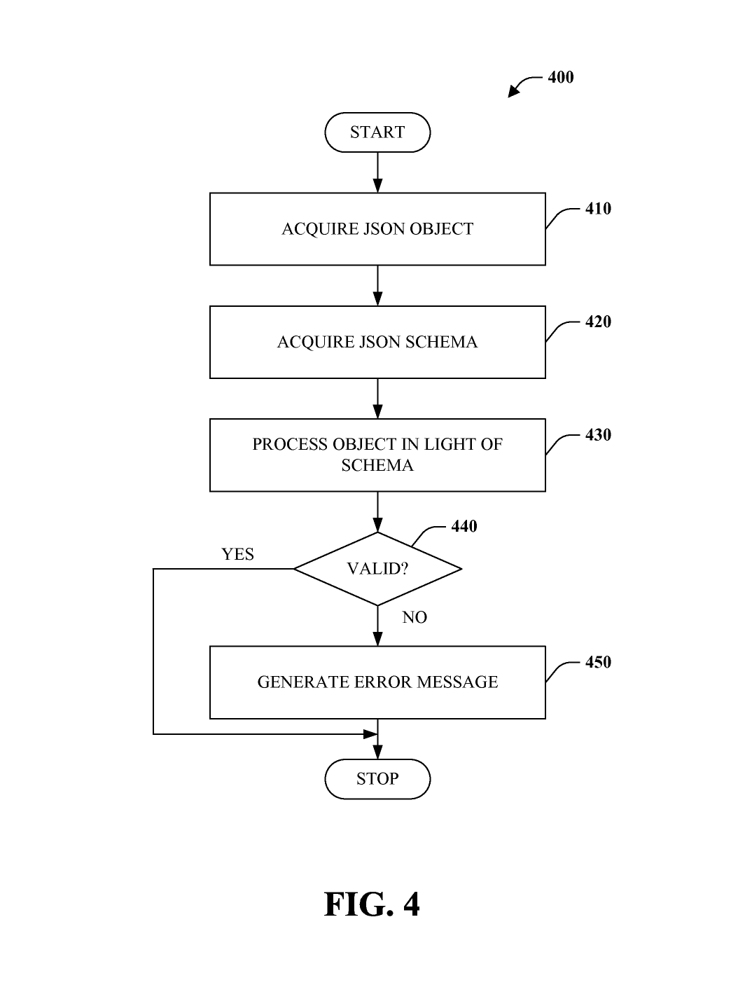

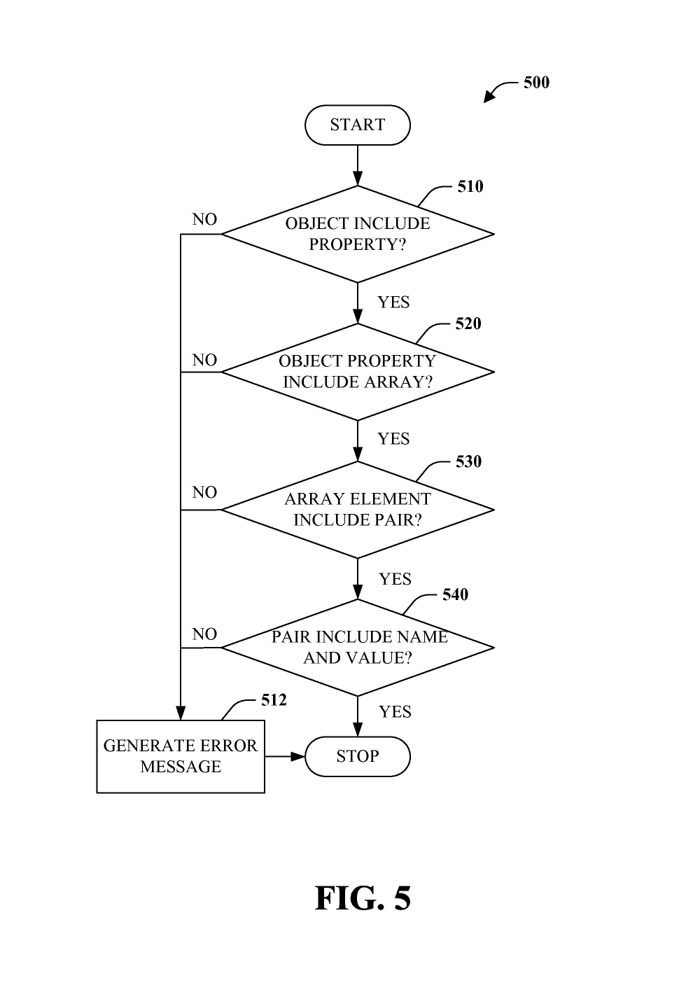

In view of the exemplary systems described supra, methodologies that may be implemented in accordance with the disclosed subject matter will be better appreciated with reference to the flow charts of FIGS. 4 and 5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a method 400 of JSON validation is illustrated. At reference numeral 410, a JSON object, or data payload, is received, retrieved, or otherwise obtained or acquired. At numeral 420, a JSON schema, specified with the powerful and intuitive schema language described herein, is received, retrieved, or otherwise obtained or acquired. At reference 430, the JSON object is processed in light of the JSON schema to access conformance. At numeral 440, a determination is made as to whether the JSON object is valid, or, in other words conforms to the JSON schema. If the JSON object is valid (“YES”), the method can simply terminate. Alternatively, if the JSON object is invalid (“NO”), an error message is generated at reference numeral 459 to identify one or more nonconformities prior to terminating. Of course, in the case of a valid JSON object a message can also be generated indicative thereof (not shown).

FIG. 5 is a flow chat diagram of a method of object validation 500. At reference numeral 510, a determination is made as to whether an object includes at least one property. If the object does not include a property (“NO”), an error message is generated at 512 indicating lack of at least one property. Alternatively, if the object does include at least one property (“YES”), the method continues at 520 where a determination is made concerning whether an object property includes an array. If the object property does not include an array (“NO”), the method proceeds to 512 to generate a message indicative thereof, prior to terminating. If the object property does include an array (“YES”), the method moves to reference numeral 530 where a determination is made as to whether an array element includes a pair. If an array element does not include a pair (“NO”), the method continues at 512 where a message is generated noting the lack of a pair prior to terminating. Alternatively (“YES”), the method proceeds to 540 where a determination concerning whether a pair includes a name and a value. If the pair does not include a name and a value (“NO”), the method continues at 512, prior to terminating, to generate a message indicating that a pair does not include a name and a value. If a pair does include a name and a value (“YES”), the method simply terminates without error.

In accordance with one aspect of the disclosure, the schema language can utilize the same syntax as the data language. Accordingly, when validation concerns JSON data, the schema definition language can utilize the syntax of JSON as well. However, the schema language is not limited to such an implementation, and thus can utilize a different syntax than that utilized to encode the data.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used this description and appended claims in is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

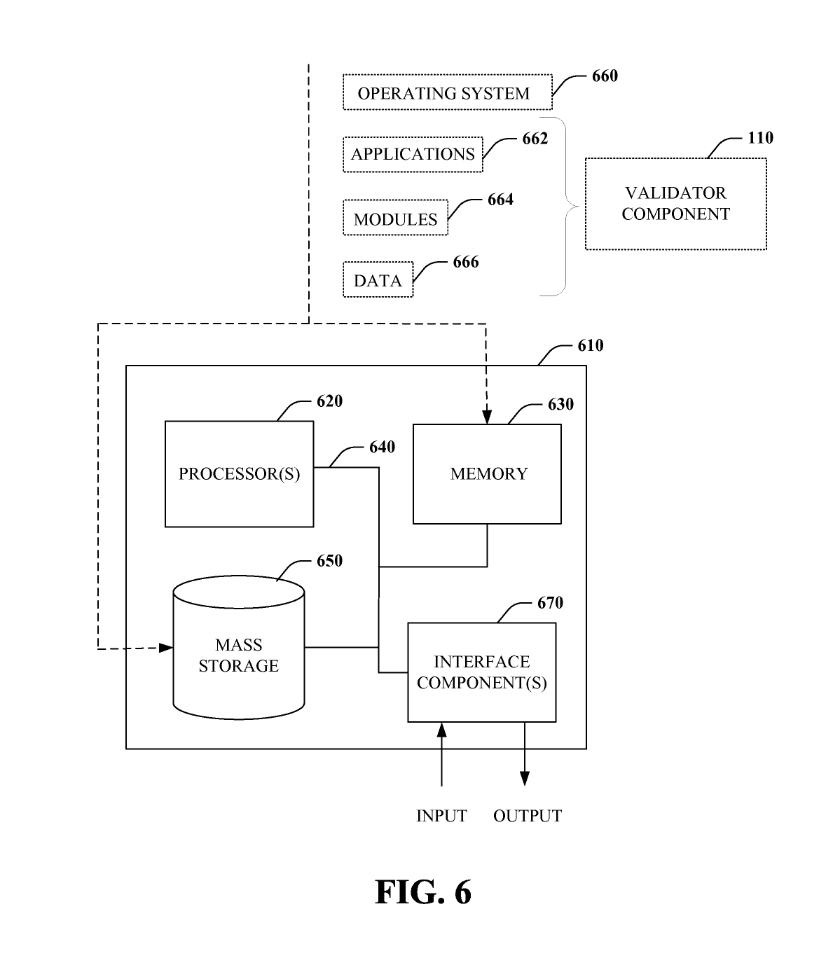

In order to provide a context for the claimed subject matter, FIG. 6 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 6, illustrated is an example general-purpose computer 610 or computing device (e.g., desktop, laptop, tablet, server, hand-held, programmable consumer or industrial electronics, set-top box, game system . . . ). The computer 610 includes one or more processor(s) 620, memory 630, system bus 640, mass storage 650, and one or more interface components 670. The system bus 640 communicatively couples at least the above system components. However, it is to be appreciated that in its simplest form the computer 610 can include one or more processors 620 coupled to memory 630 that execute various computer executable actions, instructions, and or components stored in memory 630.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration.

The computer 610 can include or otherwise interact with a variety of computer-readable media to facilitate control of the computer 610 to implement one or more aspects of the claimed subject matter. The computer-readable media can be any available media that can be accessed by the computer 610 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other physical mediums which can be used to store the desired information and which can be accessed by the computer 610. Furthermore, computer storage media excludes signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 630 and mass storage 650 are examples of computer-readable storage media. Depending on the exact configuration and type of computing device, memory 630 may be volatile (e.g., RAM), non-volatile (e.g., ROM, flash memory . . . ) or some combination of the two. By way of example, the basic input/output system (BIOS), including basic routines to transfer information between elements within the computer 610, such as during start-up, can be stored in nonvolatile memory, while volatile memory can act as external cache memory to facilitate processing by the processor(s) 620, among other things.

Mass storage 650 includes removable/non-removable, volatile/non-volatile computer storage media for storage of large amounts of data relative to the memory 630. For example, mass storage 650 includes, but is not limited to, one or more devices such as a magnetic or optical disk drive, floppy disk drive, flash memory, solid-state drive, or memory stick.

Memory 630 and mass storage 650 can include, or have stored therein, operating system 660, one or more applications 662, one or more program modules 664, and data 666. The operating system 660 acts to control and allocate resources of the computer 610. Applications 662 include one or both of system and application software and can exploit management of resources by the operating system 660 through program modules 664 and data 666 stored in memory 630 and/or mass storage 650 to perform one or more actions. Accordingly, applications 662 can turn a general-purpose computer 610 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the validator component 110 can be, or form part, of an application 662, and include one or more modules 664 and data 666 stored in memory and/or mass storage 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the validator component 110 and/or associated functionality can be embedded within hardware in a SOC architecture.

The computer 610 also includes one or more interface components 670 that are communicatively coupled to the system bus 640 and facilitate interaction with the computer 610. By way of example, the interface component 670 can be a port (e.g., serial, parallel, PCMCIA, USB, FireWire . . . ) or an interface card (e.g., sound, video . . . ) or the like. In one example implementation, the interface component 670 can be embodied as a user input/output interface to enable a user to enter commands and information into the computer 610, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 670 can be embodied as an output peripheral interface to supply output to displays (e.g., CRT, LCD, plasma . . . ), speakers, printers, and/or other computers, among other things. Still further yet, the interface component 670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

APPENDIX A
{

“root”: {

“type”: “object”,
“properties”: [

{

“type”: “pair”,
“name”: { “type”: “string”, “value”: [“root”] },
“value”:{ “type”: “ref”, “name”: “jasmin_schema” }

}

],
“extra”: [

{

“type”: “pair”,
“name”: { “type”: “string” },
“value”: {“type”: “ref”, “name”: “jasmin_schema” }

}

]

},
“jasmin_schema”: {

“type”: “choice”,
“choices”: [

{ “type”: “ref”, “name”: “jasmin_string_schema” },
{ “type”: “ref”, “name”: “jasmin_number_schema” },
{ “type”: “ref”, “name”: “jasmin_int_schema” },
{ “type”: “ref”, “name”: “jasmin_bool_schema” },
{ “type”: “ref”, “name”: “jasmin_null_schema” },
{ “type”: “ref”, “name”: “jasmin_any_schema” },
{ “type”: “ref”, “name”: “jasmin_pair_schema” },
{ “type”: “ref”, “name”: “jasmin_fail_schema” },
{ “type”: “ref”, “name”: “jasmin_object_schema” },
{ “type”: “ref”, “name”: “jasmin_array_schema” },
{ “type”: “ref”, “name”: “jasmin_choice_schema” },
{ “type”: “ref”, “name”: “jasmin_ref_schema” }

]

},
“jasmin_string_schema”: {

“type”: “object”,
“properties”: [

| | |
|---|---|
| { | “type”: “pair”, |

“name”: {“type”: “string”, “value”: [“type”] },
“value”: {“type”: “string”, “value”: [“string”] }

}

],
“extra”: [

| | |
|---|---|
| { | “type”: “pair”, |

“name”: {“type”: “string”, “value”:[“value”] },
“value”: {“type”: “array”, “elements”: [{“type”: “string”}], “extra”: [{“type”:

“string”}] }

},
{

“type”: “pair”,
“name”: {“type”: “string”, “value”: [“regex”] },
“value”: {“type”: “string” }

}

]

},
“jasmin_number_schema”: {

“type”: “object”,
“properties”: [

| | |
|---|---|
| { | “type”: “pair”, |

“name”: { “type”: “string”, “value”: [“type”] },
“value”: { “type”: “string”, “value”: [“number”] }

}

],
“extra”: [

| | |
|---|---|
| { | “type”: “pair”, |

“name”: { “type”: “string”, “value”: [“value”] },
“value”: { “type”: “array”, “elements”: [ {“type”: “number”} ], “extra”: [

{“type”: “number”} ]}

| }, | |
|---|---|
| { | “type”: “pair”, |

| | “name”: { “type”: “string”, “value”: [“max”] }, |
|---|---|
| | “value”: { “type”: “number” } |
| }, | |
| { | “type”: “pair”, |

“name”: { “type”: “string”, “value”: [“min”] },
“value”: { “type”: “number” }

}

]

},
“jasmin_int_schema”: {

“type”: “object”,
“properties”: [

| | |
|---|---|
| { | “type”: “pair”, |

“name”: { “type”: “string”, “value”: [“type”] },
“value”: { “type”: “string”, “value”: [“int”] }

}

],
“extra”: [

| | |
|---|---|
| { | “type”: “pair”, |

“name”: { “type”: “string”, “value”: [“value”] },
“value”: { “type”: “array”, “elements”: [ {“type”: “int”} ], “extra”: [ {“type”:

“int”} ]}

| }, | |
|---|---|
| { | “type”: “pair”, |

| | “name”: { “type”: “string”, “value”: [“max”] }, |
|---|---|
| | “value”: { “type”: “int” } |
| }, | |
| { | “type”: “pair”, |

“name”: { “type”: “string”, “value”: [“min”] },
“value”: { “type”: “int” }

}

]

},
“jasmin_bool_schema”: {

“type”: “object”,
“properties”: [

| | |
|---|---|
| { | “type”: “pair”, |

“name”: { “type”: “string”, “value”: [“type”] },
“value”: { “type”: “string”, “value”: [“bool”] }

}

],
“extra”: [

| | |
|---|---|
| { | “type”: “pair”, |

“name”: { “type”: “string”, “value”: [“value”] },
“value”: { “type”: “bool” }

}

]

},
“jasmin_null_schema”: {

“type”: “object”,
“properties”: [

| | |
|---|---|
| { | “type”: “pair”, |

“name”: { “type”: “string”, “value”: [“type”] },
“value”: { “type”: “string”, “value”: [“null”] }

}

]

},
“jasmin_any_schema”: {

“type”: “object”,
“extra”: [

| | |
|---|---|
| { | “type”: “pair”, |

“name”: { “type”: “string”, “value”: [“type”] },
“value”: { “type”: “string”, “value”: [“any”] }

}

]

},
“jasmin_pair_schema”: {

“type”: “object”,
“properties”: [

| { | “type”: “pair”, |
|---|---|
| | “name”: { “type”: “string”, “value”: [“type”] }, |
| | “value”: { “type”: “string”, “value”: [“pair”] } |
| }, | |
| { | “type”: “pair”, |
| | “name”: { “type”: “string”, “value”: [“name”] }, |
| | “value”: { “type”: “ref”, “name”: “jasmin_schema” } |
| }, | |
| { | “type”: “pair”, |

“name”: { “type”: “string”, “value”: [“value”] },
“value”: { “type”: “ref”, “name”: “jasmin_schema” }

}

]

},
“jasmin_fail_schema”: {

“type”: “object”,
“properties”: [

| | |
|---|---|
| { | “type”: “pair”, |

“name”: { “type”: “string”, “value”: [“type”] },
“value”: { “type”: “string”, “value”: [“fail”] }

}

]

},
“jasmin_object_schema”: {

“type”: “object”,
“properties”: [

| | |
|---|---|
| { | “type”: “pair”, |

“name”: { “type”: “string”, “value”: [“type”] },
“value”: { “type”: “string”, “value”: [“object”] }

}

],
“extra”: [

| | |
|---|---|
| { | “type”: “pair”, |

“name”: { “type”: “string”, “value”: [“inherit”] },
“value”: { “type”: “array”, “element”: [{“type”: “ref”, “name”:

“jasmin_object_schema”}], “extra”: [{“type”: “ref”, “name”: “jasmin_object_schema”}] }

| }, | |
|---|---|
| { | “type”: “pair”, |

“name”: { “type”: “string”, “value”: [“properties”] },
“value”: { “type”: “array”, “element”: [{“type”: “ref”, “name”:

“jasmin_pair_schema”}], “extra”: [{“type”: “ref”, “name”: “jasmin_pair_schema”}]}

| }, | |
|---|---|
| { | “type”: “pair”, |

“name”: { “type”: “string”, “value”: [“extra”] },
“value”: { “type”: “array”, “element”: [{“type”: “ref”, “name”:

“jasmin_pair_schema”}], “extra”: [{“type”: “ref”, “name”: “jasmin_pair_schema”}]}

}

]

},
“jasmin_array_schema”: {

“type”: “array”,
“properties”: [

| | |
|---|---|
| { | “type”: “pair”, |

“name”: { “type”: “string”, “value”: [“type”] },
“value”: { “type”: “string”, “value”: [“array”] }

}

],
“extra”: [

| | |
|---|---|
| { | “type”: “pair”, |

“name”: { “type”: “string”, “value”: [“elements”] },
“value”: { “type”: “array”, “element”: [{“type”: “ref”, “name”:

“jasmin_schema”}], “extra”: [{“type”: “ref”, “name”: “jasmin_schema”}] }

| }, | |
|---|---|
| { | “type”: “pair”, |

“name”: { “type”: “string”, “value”: [“extra”] },
“value”: { “type”: “array”, “element”: [{“type”: “ref”, “name”:

“jasmin_schema”}], “extra”: [{“type”: “ref”, “name”: “jasmin_schema”}]}

},

| | |
|---|---|
| { | “type”: “pair”, |

“name”: { “type”: “string”, “value”: [“unordered”] },
“value”: { “type”: “bool” }

}

]

},
“jasmin_choice_schema”: {

“type”: “object”,
“properties”: [

| { | “type”: “pair”, |
|---|---|
| | “name”: { “type”: “string”, “value”: [“type”] }, |
| | “value”: { “type”: “string”, “value”: [“choice”] } |
| }, | |
| { | “type”: “pair”, |

“name”: { “type”: “string”, “value”: [“choices”] },
“value”: { “type”: “array”, “elements”: [{“type”: “ref”, “name”:

“jasmin_schema”}], “extra”: [{“type”: “ref”, “name”: “jasmin_schema”}]}

}

]

},
“jasmin_ref_schema”: {

“type”: “object”,
“properties”: [

| { | “type”: “pair”, |
|---|---|
| | “name”: { “type”: “string”, “value”: [“type”] }, |
| | “value”: { “type”: “string”, “value”: [“ref”] } |
| }, | |
| { | “type”: “pair”, |

“name”: { “type”: “string”, “value”: [“name”] },
“value”: { “type”: “string” }

}

]

}

}

What is claimed is:

1. A validation system, comprising:
a processor coupled to a memory, the processor configured to execute the following computer-executable components stored in the memory:
a first component configured to verify the format of data encoded in JavaScript object notation (JSON) with a schema definition comprising an object composed of an array of one or more properties, a property composed of one or more pairs of name and value.

2. The system of claim 1, the name in a name-value pair includes a first data type and name value, and the value in the name-value pair includes a second data type.

3. The system of claim 1, the object comprises separate mandatory and optional properties.

4. The system of claim 1, the array comprises separate mandatory and optional elements.

5. The system of claim 1, the schema definition comprises a forbidden data type.

6. The system of claim 1, the schema definition comprises a root object that indicates an entry point in the schema definition.

7. The system of claim 1, the schema definition comprises a reference schema in which a schema name is defined.

8. The system of claim 7, the schema definition comprises an alternative schema that specifies a choice amongst a plurality of schemas identified by the reference schema.

9. The system of claim 1, the array is ordered.

10. The system of claim 1, the name includes a name value of type string by default.

11. A validation method, comprising:
employing at least one processor configured to execute computer-executable instructions stored in a memory to perform the following acts:
determining whether an object specified in JavaScript object notation (JSON) conforms to a JSON schema, the schema defines an object comprising properties comprising an array of one or more name value pairs.

12. The method of claim 11, determining whether the object conforms to the schema as a function of mandatory and optional elements of the array.

13. The method of claim 11, determining that the object is non-conforming upon presence of a forbidden type defined in the schema.

14. The method of claim 11, determining whether the object conforms to the schema as a function of a reference to a named schema.

15. A computer-readable storage medium having stored thereon a schema, the schema comprising:
an object comprising one or more object properties represented as an array of one or more name and value pairs.

16. The schema of claim 15 further comprises separate mandatory and optional elements of the array.

17. The schema of claim 15 further comprises separate mandatory and optional properties of the object.

18. The schema of claim 15 further comprises a forbidden type.

19. The schema of claim 15 further comprises a reference type that defines a name property corresponding to the name of a schema.

20. The schema of claim 15 further comprises a root property that identifies a leading schema amongst a plurality of schemas.
